(19) United States
(12) Patent Application Publication
(10) Pub. No.: US 2004/0227860 A1
(43) Pub. Date: Nov. 18, 2004

(54) Television restraint system

(76) Inventors: Pasqualino DePaolo, Rutledge, PA (US); Allen L. Venditti, Broomall, PA (US); Armand M. Vozzo JR., Glenside, PA (US)

Correspondence Address: Armand M. Vozzo, Jr., Esquire, 19 Short Road, Doylestown, PA, 18901, US

(21) Appl. No.: 10/843,781

(22) Filed: May 12, 2004

Related U.S. Application Data
(60) Provisional application No. 60/470,811, filed on May 15, 2003.

(51) Int. Cl. H04N 5/64; H04N 5/645

(52) U.S. Cl. 348/825; 348/836

(57) ABSTRACT

An improved restraint system is disclosed for preventing a television set from tipping over and falling from a mounted position upon a table surface. The present system comprises an upper harness having a pair of adjustable straps joined together at their base in a bifurcated configuration, each of the straps being provided at their uppermost ends with a clip member having a hook-like form intended to engage the rear housing cover of a conventional television set. The upper harness straps are secured at their base to a mounting plate adapted for attachment to the back edge of the table surface so that the upper harness straps may extend upward onto the rear housing cover and engage both sides thereof via the clip members. A separate lower anchor strap, also adjustable in length, is further secured to the mounting plate and adapted to extend downward and outward having a base plate connected at its lower end that may be secured to the floor or wall in proximity to the table to maintain its stationary position and stabilize the television mounted thereon.

### CROSS-REFERENCE TO RELATED APPLICATION

This application is a continuation-in-part Provisional Application Serial No. 60/470,811, filed May 15, 2004 for Television Restraint System.

### BACKGROUND OF THE INVENTION

The present invention generally relates to devices used to restrain equipment, and more particularly to a restraint system for a television set mounted upon a table which comprises an upper harness of adjustable straps in a bifurcated arrangement secured to the table and adapted to engage the rear of the television set and a lower anchor strap similarly secured to the table and fitted for attachment to an adjacent wall or floor surface to prevent the television set from tipping forward and falling from the table.

Television sets in various shapes and sizes are found in virtually every home and apartment as well as in hotels, motels and boarding rooms throughout the country. In many of these locations, the television set is found on the flat surface of a table or stand where the weight of the set generally prevents it from moving about. While these so-called “tabletop” televisions remain stationary for the most part, due to their relatively large size and uneven weight distribution, they are often at risk of tipping forward and toppling from the table, consequently resulting in significant property damage and personal injury. Over the last decade, the U.S. Consumer Product Safety Commission has reported many instances of serious personal injuries and even deaths caused by what the Commission calls “TV Tipovers”, with most of the victims being unsuspecting children.

Rigid mounting brackets that are secured to a wall surface near to the television set can be effective to hold the set in a stationary position and keep it from toppling. These brackets, however, are difficult to position properly and generally mar the wall surface upon which they are attached. With no other known devices being heretofore presented to prevent these harmful TV tipovers, there is a need for a simple and effective television restraint system.

### SUMMARY OF THE INVENTION

Accordingly, it is a general purpose and object of the present invention to provide an improved system for restraining a television set upon the top surface of a table or mounting stand to prevent the set from tipping forward and toppling to the floor.

A more particular object of the present invention is to provide a restraint system for a television set that secures the set in a stable and stationary position upon the top of a table or other elevated surface so that the television set resists any forced movement made upon the set or the table.

Another object of the present invention is to provide a television restraint system capable of stabilizing a tabletop television set upon a table surface in a mounted arrangement that is resistant to forces that otherwise would cause them to tip and topple over.

Still another object of the present invention is to provide a television restraint system that is readily deployed and placed upon a standard television set in a simple and inconspicuous manner and without any obstruction.

A still further object of the present invention is to provide a television restraint that is reliable, easy to make and assemble, and adaptable to a variety of television sets and their mounting arrangements.

Briefly, these and other objects of the present invention are accomplished by an improved restraint system for preventing a television set from tipping over and falling from a mounted position upon a table surface. The present system comprises an upper harness having a pair of adjustable straps joined together at their base in a bifurcated configuration, each of the straps being provided at their uppermost ends with a clip member having a hook-like form intended to engage the rear housing cover of a conventional television set. The upper harness straps are secured at their base to a mounting plate adapted for attachment to the back edge of the table surface so that the upper harness straps may extend upward onto the rear housing cover and engage both sides thereof via the clip members. A separate lower anchor strap, also adjustable in length, is further secured to the mounting plate and adapted to extend downward and outward having a base plate connected at its lower end that may be secured to the floor or wall in proximity to the table to maintain its stationary position and stabilize the television mounted thereon.

For a better understanding of these and other aspects of the present invention, reference should be made to the following detailed description taken in conjunction with the accompanying drawings in which like reference numerals and character designate like parts throughout the figures thereof.

### BRIEF DESCRIPTION OF THE DRAWINGS

For a fuller understanding of the nature and objects of the present invention, references in the detailed description set forth below shall be made to the accompanying drawings in which:

FIG. 1 is a plan view of a layout of the restraint system according to the present invention;

FIG. 2 is a sectional view of FIG. 1 taken along the line 2-2;

FIG. 3 is a perspective view of the restraint system of FIG. 1 secured in place upon the rear of a television set and its mounting table in accordance with the present invention;

FIG. 4 is a side elevation view of the restraint system shown in FIG. 3; and

FIG. 5 is a view in elevation of an alternate embodiment of the restraint system according to the present invention secured between the rear of a television set and its mounting table.

### DETAILED DESCRIPTION OF THE INVENTION

The following is a detailed description of a preferred embodiment of the present invention and the best presently contemplated mode of its production and practice. This description is further made for the purpose of illustrating the general principles of the invention but should not be taken in a limiting sense, the scope of the invention being best determined by reference to appended claims.

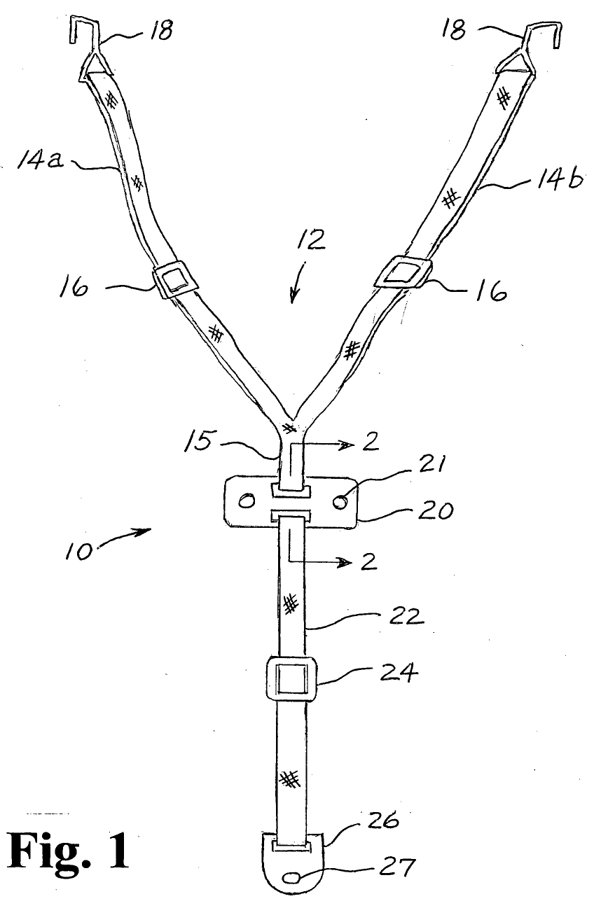

Referring now to FIG. 1, a preferred embodiment of the present television restraint system, generally designated 10, comprises an upper harness 12 having a pair of straps 14a, 14b adjustable in their respective lengths and joined together at the base ends thereof. Each of the straps 14a. 14b are similarly constructed and fabricated of a high-strength and flexible woven material, such as nylon or polyester, secured together and joined by conventional stitching to form a bifurcated configuration, as shown in FIG. 1, having a shortened strap segment 15 extending downward from the base joint of the straps at the bottom of upper harness 12. The lengths of the upper straps 14a, 14b are adjustable in their extension from the base joint, each strap being routed through a conventional adjusted buckle 16 movably disposed thereon.

The top end of each of the upper straps 14a.14b is engaged upon and fastened to a respective clip member 18. Each clip member 18 is fabricated from a strong and relatively rigid metallic wire material, such as steel wire, that is formed having a loop at the lower end of the clip member to secure its connection with respective straps 14a, 14b and further formed having a hook-like configuration at the upper end that is adapted in shape and size to engage the slotted openings typically found on the rear housing cover of conventional television sets for ventilation purposes. The hook-like configuration of the respective clip members 18 may be rectilinear (as shown) or curved in its formation, and may be varied in its dimensions in order to best secure its intended engagement with the rear cover of the television set.

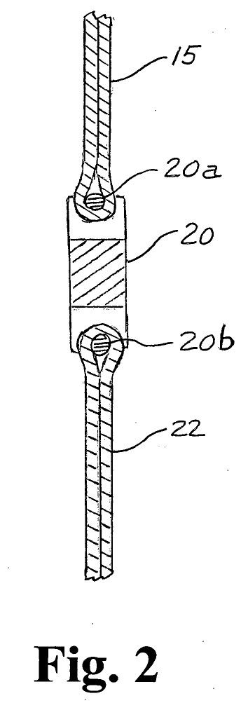

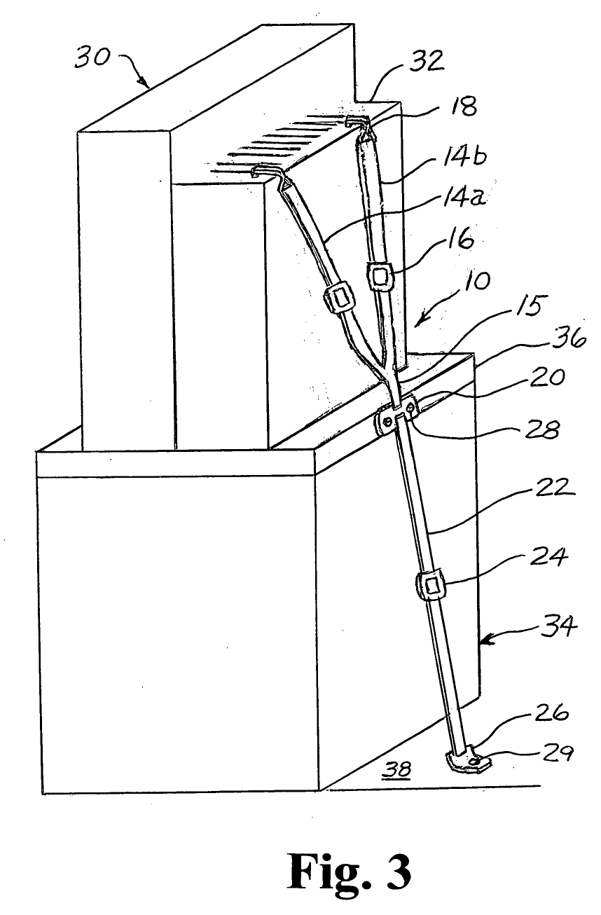

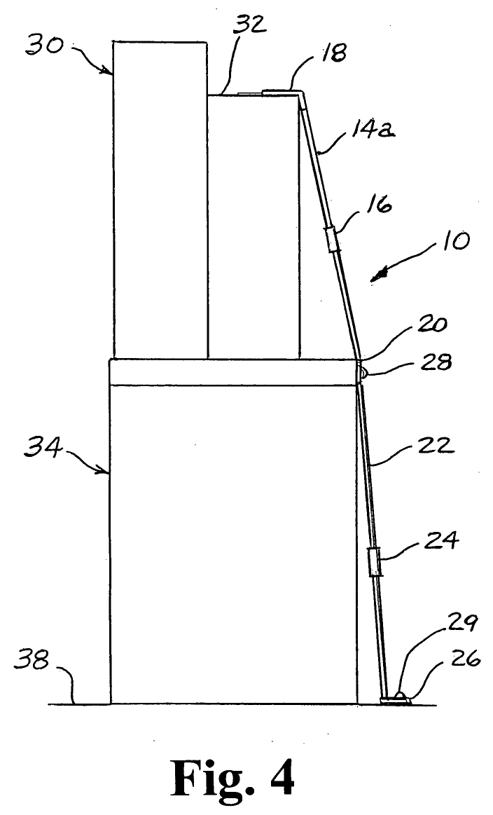

Referring now to FIG. 2 in conjunction with FIG. 1, the base of the strap segment 15 at the bottom of upper harness 12 is engaged upon and secured to a mounting plate 20. The mounting plate is a rigid planar member that is slotted near the top edge of the plate to accept the strap segment 15 the end of which is looped and fastened about a crossing member 20a integrally formed along the top edge of the plate. The mounting plate 20 is similarly slotted along its bottom edge, providing an opening with integral crossing member 20b to accept and secure an anchor strap 22 to the bottom of the mounting plate in the same fashion as that of the strap segment 15 at the top. A pair of holes 21 are further provided through the mounting plate 20 on either side thereof to facilitate screw attachment of the plate and the assembled restraint system 10 to the back surface 36 of a television mounting table 34, as shown and described in further detail below with respect to FIGS. 3 and 4.

The lower anchor strap 22 is similarly constructed to the upper straps 14a, 14b and fabricated of the same flexible woven material. The anchor strap 22 is likewise adjustable in its length by way of an adjuster buckle 24 movably disposed along the strap. The upper end of anchor strap 22 is secured to the bottom of mounting plate 20, the strap being looped through the slotted opening and fastened about the crossing member 20b along the bottom edge. The lower end of the anchor strap 22 is engaged upon and fastened to a base plate 26 in similar fashion to the upper end. The base plate 26 is a rigid planar member similar in its fabrication to the intermediate mounting plate 20 but having a slotted opening at one end to engage the lower end of the anchor strap 22 and a hole 27 through the base plate at the opposite end thereof to permit its attachment to a floor or wall surface by means of a screw 29 or other conventional fastener.

Referring now to FIGS. 3 and 4, the restraint system of FIGS. 1 and 2 is shown in operative deployment, mounted to the rear of table 34 upon which television set 30 normally rests. With the mounting plate 20 attached to the back edge 36 of the table 34 using conventional screws 28 secured through holes 21, the upper harness 12 is extended upward and onto the rear of television set 30 so that the upper straps 14a, 14b may be fastened to the rear housing cover 32 by engagement of the respective clip members 18 with the slotted surface of the rear cover, preferably at opposites sides thereof. Once fastened to the rear housing cover 32, the upper straps 14a, 14b are adjusted in their respective lengths using the respective buckles 16 and together tightened to secure the restraint of the television set 30 to the top of table 34. Separately from the upper harness 12 and its associated straps 14a and 14b, the lower anchor strap 22 with its base plate 26 is extended downward and outward, as necessary, from the mounting plate 20 to reach the floor 38 or other stationary surface, such as a near wall. The base plate 26 is attached to the floor 38 or other proximate stationary surface by screw 29 or other conventional fastener and once the base plate is attached, the anchor strap 22 is adjusted in length using buckle 24 and then tightened to secure the normal position of the table 34.

It should be noted and understood that the anchor strap 22 with its base plate 26 works independently but together with the upper harness 12 to stabilize the mounted arrangement of both the television set 30 and the underlying table 34 thereby preventing the mounted arrangement from toppling over together under an unexpected force applied to either piece. While the upper harness 12 of adjustable straps 14a, 14b secured to the table 34 via mounting plate 20 effectively serves to restrain the television set 30 from forces acting thereupon that could cause the set to fall over and from the table 34, the anchor strap 22 and its base plate 26 attachment further serves to resist forces acting upon either the television set or the underlying table that might otherwise cause them together to tip and topple over.

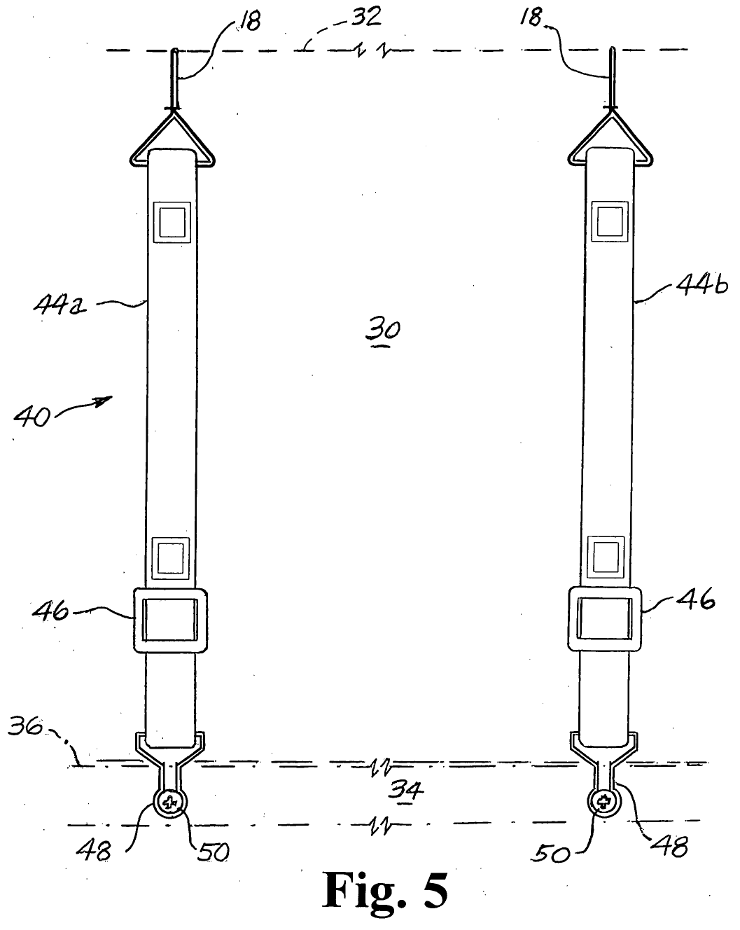

Referring now to FIG. 5, an alternate embodiment of the inventive restraint system, therein generally designated 40, is shown in operative engagement upon the rear cover housing 32 of television set 30 and connected to the back edge surface 36 of the mounting table 34, those elements not part of the present invention being shown in phantom. It should be recognized that the modified restraint system 40 of FIG. 5 particularly provides an alternative to the upper harness 12 and its bifurcated straps 14a, 14b. The modified restraint system 40 includes a separate pair of straps 44a and 44b, each similar in construction and fabrication to the bifurcated straps 14a, 14b of upper harness 12. Each of the separate straps 44a and 44b is fastened about and connected at their respective upper ends to clip members 18 formed, as described above, to engage slotted openings atop the rear housing cover 32. An adjuster buckle 46, similar to those described above, is movably disposed upon each of the separate straps 44a and 44b to allow the working length of each strap to be adjusted. At the lower ends of the separate straps 44a and 44b, each strap is fastened about and connected to an attachment lug 48 made of a rigid wire-like material similar to that of clip member 18. The attachment lug 48 is a continuous member formed having a substantially flat base segment about which the ends of the respective straps 44a and 44b are fastened and further having converging sides that extend from the base segment and close in a wedge-like manner so as to engage the head of a screw or stud member 50 infixed upon and projecting from the back edge surface 36 of the mounting table 34. With the attachment lugs 48 at the bottom of the separate straps 44a, 44b engaged upon respective stud members 50, the clip members 18 at the top of the straps are engaged upon the rear housing cover 32. Once both ends of the separate straps 44a and 44b are thus secured, the straps may be adjusted via buckles 46 and tightened sufficiently to restrain the position of the television set 30 upon the table 34. The additional mounting of a separate anchor strap 22 and associated base plate 26 between the back surface 36 of the table 34 and a proximate stationary surface, as previously described in restraint system 10, may be likewise employed with this modified restraint system 40 to further restrain the television set 30 and stabilize the entire mounted arrangement.

Therefore, it is apparent that the described invention generally provides an improved system for restraining a television set upon the top surface of a table or mounting stand to prevent the set from tipping forward and toppling to the floor. More particularly, the present invention provides a restraint system for a television set that secures the set in a stable and stationary position upon the top of a table or other elevated surface so that the television set resists any forced movement made upon the set or the table. The present television restraint system is further capable of stabilizing a tabletop television set upon a table surface in a horizontal or slightly inclined arrangement and is resistant to forces that otherwise would cause the television and its mounting table to tip and topple over. It should be further evident that the described restraint system may readily deployed and placed upon a standard television set in a simple and inconspicuous manner and without any viewer obstruction. In addition, the described television restraint system is easy to make and assemble, reliable in its performance and adaptable to a variety of television sets and their mounting arrangements.

Obviously, other embodiments and modifications of the present invention will readily come to those of ordinary skill in the art having the benefit of the teachings presented in the foregoing description and drawings. Alternate embodiments of different shapes and sizes, as well as substitution of known materials or those materials which may be developed at a future time to perform the same function as the present described embodiment are therefore considered to be part of the present invention. Accordingly, it is understood that this invention is not limited to the particular embodiment described, but rather is intended to cover modifications within the spirit and scope of the present invention as expressed in the appended claims.

What is claimed:

1. A system for restraining a television set upon a table elevated above a floor surface, comprising:
harness means fitted to engage the television set and made to extend across the rear thereof; and
a mounting plate fastened to said harness means and adapted for attachment to the table to secure said harness means thereto and thereby prevent the television set from tipping forward and falling onto the floor surface.

2. The television restraint system according to claim 1, further comprising:
anchor strap means connected to said plate member and fitted to attach to the floor surface to stabilize the table on the floor surface and thereby further prevent the television set from tipping forward and falling from the table.

3. The television restraint system according to claim 1, wherein said harness means comprises:
a pair of strap members each adjustable in their respective lengths; and
a pair of clip members, one of said clip members being respectively connected to an upper end of each of said strap members to engage the rear of the television set.

4. The television restraint system according to claim 3, wherein said pair of strap members are joined at the lower ends thereof in a bifurcated configuration having a single strap segment extending from the base thereof.

5. The television restraint system according to claim 3, wherein each of said clip members is formed having a hook-like configuration adapted to engage the rear of the television set.

6. The television restraint system according to claim 2, wherein said anchor strap means comprises:
an anchor strap adjustable in length and adapted to connect to said plate member at one end thereof; and
a base plate connected to the opposite end of said anchor strap and adapted to permit attachment to the floor surface.

7. A restraint system for a television set mounted upon a table above a floor surface, comprising:
a pair of upper strap members each adjustable in the respective lengths thereof;
a clip member secured to the top of each of said upper strap members and formed to engage the rear of the television set; and
means for attaching the bottom of said upper strap members to the table to prevent the television set from tipping forward and falling onto the floor surface.

8. The television restraint system according to claim 7, further comprising:
a lower strap member connected at one end thereof to said attaching means and fitted at the other end for attachment to the floor surface to stabilize the table on the floor surface and further prevent the television set from tipping forward and falling from the table.

9. The television restraint system according to claim 8, wherein said upper straps are joined at the bottom thereof in a bifurcated configuration having a single strap segment extending therefrom.

10. The television restraint system according to claim 9, wherein said clip member is formed having a hook-like configuration adapted to engage the rear of the television set.

11. The television restraint system according to claim 9, wherein said attaching means comprises a plate member mounted to the table and fitted to receive the single strap segment of said upper straps and said lower strap.

12. The television restraint system according to claim 8, wherein said lower strap is adjustable in length.
